(19) United States
(12) Patent Application Publication
(10) Pub. No.: US 2010/0149207 A1
(43) Pub. Date: Jun. 17, 2010

(54) GRAYSCALE CHARACTERISTIC FOR COLOR DISPLAY DEVICE

(76) Inventors: Thomas E. Madden, Fairport, NY (US); Esther M. Betancourt, Rochester, NY (US)

Correspondence Address: EASTMAN KODAK COMPANY;PATENT LEGAL STAFF, 343 STATE STREET, ROCHESTER, NY, 14650-2201, US

(21) Appl. No.: 12/621,735

(22) Filed: Nov. 19, 2009

Related U.S. Application Data
(60) Provisional application No. 61/116,756, filed on Nov. 21, 2008.

(51) Int. Cl. G09G 5/02

(52) U.S. Cl. 345/596

(57) ABSTRACT

An original reference grayscale characteristic for a display panel is created by modifying the sRGB reference grayscale characteristic for the display panel. The changes selectively vary the relative luminances and contrasts of certain regions of the sRGB reference grayscale characteristic. The display device code values for the original reference grayscale characteristic comprise a substantially constant chromaticity corresponding to a particular CIE standard illuminant between D70 and D85 throughout the entire grayscale characteristic. A portion of the display device code values in the original reference grayscale characteristic are changed to provide a taper to a black chromaticity of the display panel in the lower portion of the grayscale characteristic.

### CROSS REFERENCE TO RELATED APPLICATIONS

This application claims the benefit of U.S. Provisional Patent Application 61/116,756 filed on Nov. 21, 2008, which is incorporated herein by reference.

### TECHNICAL FIELD

The present invention relates to display devices. More particularly, the present invention relates to non-CRT display devices. Still more particularly, the present invention relates to a method and system for producing a grayscale characteristic for non-CRT display devices.

### BACKGROUND

Digital-still cameras capture and digitize images and store the digitized images as digital image files. The image data file format may correspond to known formats, such as the Tagged Image File Format (TIFF) or more commonly to the JPEG image data file format, where digital image compression techniques are employed to reduce the data storage requirements.

The digital image data values, comprised of the color image information corresponding to each pixel location within a digital image, are also expressed in terms of a color encoding specification. The color encoding specification allows the encoded color image information to be used to create reproduced images on a variety of color-imaging media and devices. Image data files created by digital still cameras are commonly expressed in terms of the sRGB color encoding specification. The sRGB specification is embodied in a standard document BS EN 61966-2-1:2000 IEC 61966-2-1:1999 entitled “Multimedia systems and equipment—Colour measurement and management—Part 2-1: Colour management—Default RGB colour space—sRGB”.

The sRGB color space is defined in terms of a reference Cathode Ray Tube (CRT) display system. Color-imaging devices that are intended to read and display digital images encoded in terms of the sRGB color space typically are designed to replicate the colorimetric behavior of the sRGB reference CRT-based display system. CRT-based displays, however, have largely been supplanted in the marketplace by other display technologies including, but not limited to, Liquid Crystal Display (LCD), Light Emitting Diode (LED), plasma, and Organic Light Emitting Diode (OLED).

FIG. 1 depicts the grayscale characteristics a particular LCD display panel and the sRGB reference CRT expressed in terms of luminance-factor values versus input equal RGB code value. All other factors being equal, simply displaying a particular sRGB-encoded image using the LCD panel having the grayscale characteristic depicted in plot 100 would produce displayed image relative colorimetry quite different from that which would result using the sRGB reference display system grayscale (plot 102). Specifically, the midscale and highlight tones of the image would be reproduced relatively lighter and generally higher in contrast on the LCD display system (see area 104) than they would be reproduced on the sRGB reference display system as intended. Further, the shadow tones of the image would be displayed relatively darker on the LCD display system (see area 106) than they would be on the sRGB reference display system. Further still, some portions of the shadow tones would be higher in contrast and some portions of the shadow tones would be lower in contrast on the LCD display system than on the sRGB reference display system.

This is just one example. A particular display device grayscale characteristic can vary considerably from this example depending on the basic display technology employed (LCD, plasma, OLED, etc.), sub-technologies within a given basic technology (twisted nematic vs. in-plane switching LCD technologies, for example), differences caused by manufacturing variation in individual units of the same type, as well as differences caused by the particular digital and/or analog electronics and software or firmware integrated with the panel in the device.

Because of such differences in the underlying physical grayscale responses of LCD, plasma, OLED and other display technologies and that of the sRGB reference display system, as well as grayscale differences of other CRT-based displays and the sRGB reference display system, most displays, or the hardware, firmware, or software with which they may be integrated, have internal compensation capability that can be used to cause the display device to emulate the grayscale characteristic of the sRGB reference display system.

However, even when compensation between the relative colorimetric properties of an actual display device and the sRGB reference display system is applied, appropriately encoded sRGB images can appear much too light and low in overall color saturation when displayed on some display devices. This is due in part to the peak white luminance of some devices exceeding the defined peak white luminance for the sRGB color space. The peak white luminance for the sRGB color space is 80 cd/m². Today's digital picture frames, for example, can have peak luminances ranging from 125 cd/m² to 300 cd/m² and higher. The peak white luminances produced by LCD television receivers can measure as high and 500 or 600 cd/m² and more.

There are further differences that also must be considered between the sRGB color space viewing conditions and those typically encountered for devices such as digital picture frames and the like. For example, it is widely recognized that the sRGB color space viewing condition was based on the conditions under which computer workstation color CRT monitors were typically viewed when they were prevalent. It is therefore likely that the assumed sRGB displayed image is intended to fill a larger field of view for the observer than would an image typically displayed on today's digital picture frame devices. The assumed sRGB computer monitor displayed image size generally would be considered to be physically larger and viewed from a shorter distance than would a digital picture frame image which is generally smaller in physical size and most often viewed from a much greater distance. Therefore, the subtended image sizes can be quite different in that an sRGB-encoded image may have been intended to be displayed and viewed under conditions where there is some degree of visual adaptation to the displayed image itself.

Conversely, images displayed on digital picture frame devices and other smaller display devices are typically viewed under conditions where the frame device and the displayed image are seen more as objects within a larger viewing environment, and there is little, if any, visual adaptation to the displayed image itself. The visual adaptation is influenced predominantly by the overall environment in which the frame device is placed. The small physical size of the devices and the greater viewing distances typically involved in viewing the displayed images result in relatively small angular subtenses for the viewed images.

The visual phenomena arising from differences in image viewing conditions are enumerated and explained in numerous books and articles, including the book by Edward J. Giorgianni and Thomas E. Madden entitled “Digital Color Management: Encoding Solutions”, Prentice Hall 1998 (ISBN 0201634260). This book states that in cases where there is a large degree of visual adaptation to the image itself, it is acceptable, and often desirable, to display the image at a somewhat lower overall relative luminance level than would be the case if the same image were displayed under conditions where there is little or no adaptation to the image itself. This option provides the advantage in the former case to allocate a portion of the higher luminance region of the display's luminance dynamic range for display color-image information corresponding to image subject matter having luminance levels greater than that of a diffuse white in the principal subject area of the scene, thus providing an increased reproduced luminance range for displaying image highlight areas and enhancing the overall visual quality of the displayed image. The colorimetry of such images wherein the technique of lowering the overall reproduced luminances to enhance visual image quality in cases where there is significant adaptation to the image itself, however, is inappropriate for creating reproduced images in viewing situations where there is little or no adaptation to the image itself. If that were done, the displayed colorimetry would appear much too dark overall, and the observer will not adapt to the displayed colorimetry.

That would suggest then that the reproduced colorimetry of an sRGB-encoded image intended to be displayed and viewed according to the sRGB standard, should be increased in its overall luminance, relative to the reproduced colorimetry determined according to the physical colorimetric characteristics of the sRGB reference display system, if the reproduced image it is to be displayed under conditions in which there is little or no adaptation to the displayed image itself, as would be the case for a digital picture frame device where the device and its displayed image are seen and interpreted as objects within a larger viewing environment, the conditions of which will influence the observer's state of visual adaptation.

These rules of thumb around image relative luminance where there is little or no adaptation to the image itself apply however to situations where the average luminance of the color stimuli of the displayed image are approximately equal to the luminances of other objects in the viewing environment, as is the case for reflection-print images presented and viewed without the use of preferential lighting (i.e. the light illuminating the print is similar to the light in the overall viewing environment).

However, as was mentioned for the case of many of today's digital picture frame devices, the peak luminances of the displayed images can be much higher than the luminances that would be measured for an illuminated diffuse white reflecting object placed in the same physical location in the viewing environment as the digital picture frame.

Despite the fact that digital picture frame images generally are viewed as objects within a viewing environment with little or no adaptation to the displayed image itself, sRGB-encoded images are typically displayed somewhat darker, on a relative basis, on digital picture frame devices compared to images displayed on an sRGB reference display system and viewed under sRGB viewing conditions. Creating the relatively physically darker displayed image required for the digital picture frame display device can be accomplished by simply reducing the level of backlight to an LCD-based digital picture frame device, by employing lookup table compensation in the device that reduces the overall luminances produced, or by scaling the sRGB luminance values. However, reducing all the sRGB reference display device grayscale luminances by a given amount sacrifices the reproduction of a large portion of the shadow region of the grayscale. Moreover, the peak displayed luminance is reduced relative to the device's maximum physical capability. This hampers a manufacturer's ability to advertize higher peak luminances to distinguish their devices from those of competitors.

### SUMMARY

An original reference grayscale characteristic for a display panel is created by modifying the sRGB reference grayscale characteristic for the display panel. The changes selectively vary the relative luminances and contrasts of certain regions of the sRGB reference grayscale characteristic. In one embodiment in accordance with the invention, the original reference grayscale characteristic is relatively darker overall than the sRGB reference grayscale characteristic for all points along the curve other than the black point and the white point. The contrast of the shadow and darker midtone regions of the sRGB reference display system grayscale characteristic are lowered while the contrast of the highlight and lighter midtone regions of the sRGB reference display system grayscale characteristic are increased. The display device code values for the original reference grayscale characteristic comprise a substantially constant chromaticity corresponding to a particular CIE standard illuminant between D70 and D85 throughout the entire grayscale characteristic. By way of example only, one dimensional lookup tables are computed to produce an original reference grayscale characteristic having a constant chromaticity corresponding to that of CIE standard illuminant D75 throughout the entire grayscale characteristic in an embodiment in accordance with the invention. A portion of the display device code values in the original reference grayscale characteristic are changed to provide a taper to a black chromaticity of the display panel in the lower portion of the grayscale characteristic.

### ADVANTAGEOUS EFFECT(S)

The present invention provides a method for improving the display of digital image files using a display device where scene neutrals, captured and encoded according to the sRGB color space are reproduced in a visually preferred manner. The reproduced neutrals appear achromatic to an observer adapted to the display viewing environment. The present invention also results in the chromaticity coordinates of the reproduced neutrals lying substantially along the continuum of chromaticities corresponding to CIE standard daylight illuminants, where the chromaticities are constant throughout a majority of the display luminance dynamic range. The present invention also improves contrast ratio by producing a taper in the lower end of the tables.

### BRIEF DESCRIPTION OF THE DRAWINGS

Embodiments of the invention are better understood with reference to the following drawings. The elements of the drawings are not necessarily to scale relative to each other.

FIG. 1 depicts the grayscale characteristics a particular LCD display panel and the sRGB reference CRT expressed in terms of luminance-factor values versus input equal RGB code value;

FIG. 2 is a block diagram of a display system in an embodiment in accordance with the invention;

FIG. 3 is a flowchart illustrating a method for producing an original reference grayscale characteristic for a particular display panel in an embodiment in accordance with the invention;

FIG. 4 depicts a sRGB reference grayscale characteristic and an original reference grayscale characteristic for a non-CRT display panel in an embodiment in accordance with the invention;

FIG. 5 depicts grayscale compensation lookup tables are shown for a display device in a first embodiment in accordance with the invention;

FIG. 6 illustrates grayscale compensation lookup tables are shown for a display device in a second embodiment in accordance with the invention.

FIG. 7 depicts a grayscale tracking plot for a liquid crystal display according to the prior art; and

FIG. 8 illustrates a grayscale tracking plot for a liquid crystal display in an embodiment in accordance with the invention.

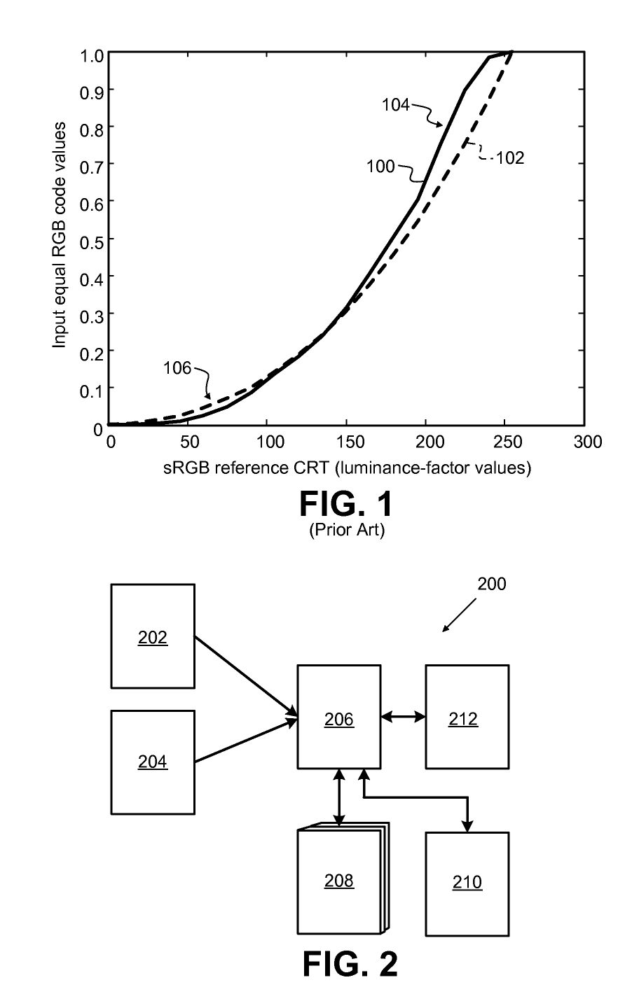

### DETAILED DESCRIPTION

Throughout the specification and claims, the following terms take the meanings explicitly associated herein, unless the context clearly dictates otherwise. The meaning of “a,” “an,” and “the” includes plural reference, the meaning of “in” includes “in” and “on.” The term “connected” means either a direct electrical connection between the items connected, or an indirect connection through one or more passive or active intermediary devices. The term “circuit” means either a single component or a multiplicity of components, either active or passive, that are connected together to provide a desired function. The term “signal” means at least one current, voltage, or data signal.

Referring to the drawings, like numbers indicate like parts throughout the views.

FIG. 2 is a simplified block diagram of a display system in an embodiment in accordance with the invention. Display system 200 includes image capture device 202, one or more other types of input devices 204, and processor 206. Image capture device 202 or input device 204 transmit one or more digital image files expressed in terms of the sRGB color encoding specification to processor 206 in an embodiment in accordance with the invention.

Processor 206 is configured, for example, as a microprocessor, a central processing unit (CPU), an application-specific integrated circuit (ASIC), a Field Programmable Gate Array (FPGA), a digital signal processor (DSP), or other processing device, or combinations of multiple such devices, in one or more embodiments in accordance with the invention. Processor 206 may store the one or more digital image files in memory 208. Memory 208 is implemented as any type of memory, such as, for example, random access memory (RAM), DRAM, SDRAM, flash memory, disk-based memory, removable memory, or other types of storage elements, in any combination, in an embodiment in accordance with the invention.

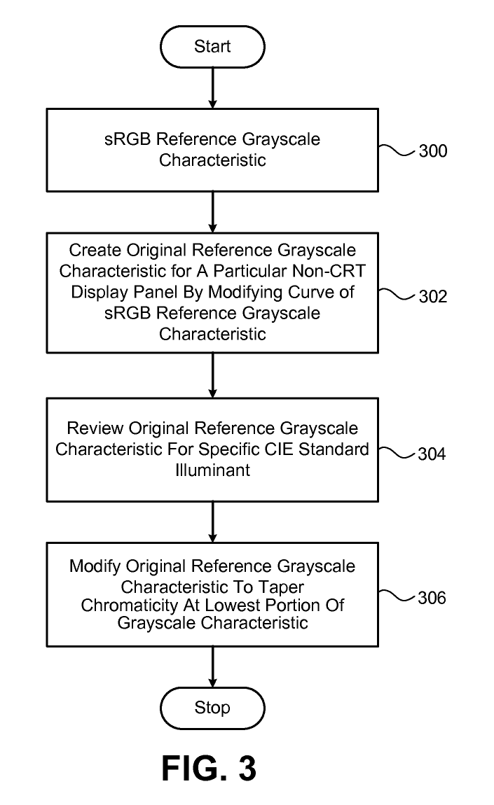

Communications port 210 is an input/output port for communicating with other devices and networks, such as, for example, various on-screen controls, buttons or other user interfaces, network interfaces, and remote or voice control interfaces. And finally, display 212 is used to display the one or more digital image files. Display 212 is configured as a liquid crystal display (LCD), an organic light emitting diode (OLED) display, a plasma display panel (PDP), a projection display, or other non-CRT display technology in one or more embodiments in accordance with the invention. When processor 206 performs the method shown in FIG. 3, display 212 will display the one or more digital image files with improved grayscale reproduction.

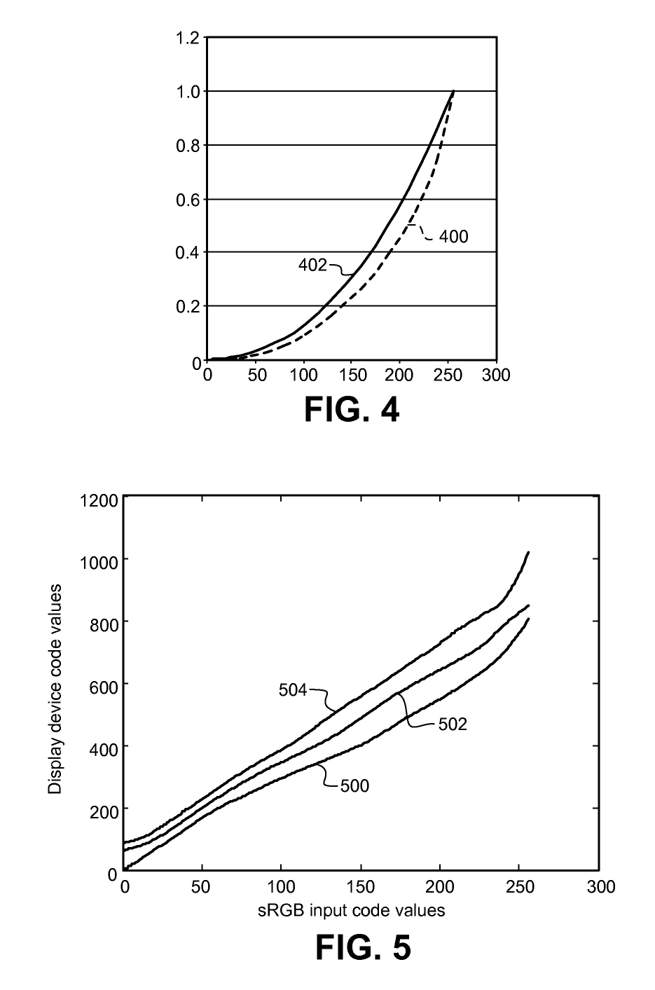

Referring now to FIG. 3, there is shown a flowchart illustrating a method for producing an original reference grayscale characteristic for a particular display panel in an embodiment in accordance with the invention. Initially, the sRGB reference grayscale characteristic for a particular non-CRT display panel is reviewed, as shown in block 300. Next, an original reference grayscale characteristic is created by modifying the sRGB reference grayscale characteristic for the particular non-CRT display panel, as shown in block 302. The modifications are made by manually changing the relationship between the sRGB input code values and the display device code values in an embodiment in accordance with the invention. The changes selectively vary the relative luminances and contrasts of certain regions of the sRGB reference grayscale characteristic. For example, in one embodiment in accordance with the invention, an original reference grayscale characteristic 400 shown in FIG. 4 is relatively darker overall than the sRGB reference grayscale characteristic 402 for all points along the curve other than the black point and the white point. The contrast of the shadow and darker midtone regions of the sRGB reference display system grayscale characteristic are lower in the original reference grayscale characteristic while the contrast of the highlight and lighter midtone regions of the sRGB reference display system grayscale characteristic are higher in the original reference grayscale characteristic. In particular, the slope of the original reference grayscale characteristic 400 is lower, or slopes of portions of the original grayscale characteristic 400 are lower, in those areas where the contrast of the shadow and darker midtone regions of the sRGB reference display system grayscale characteristic are lowered. The slope of the original reference grayscale characteristic 400 is increased, or slopes of portions of the original grayscale characteristic are increased, in those areas where the contrast of the highlight and lighter midtone regions of the sRGB reference display system grayscale characteristic are increased.

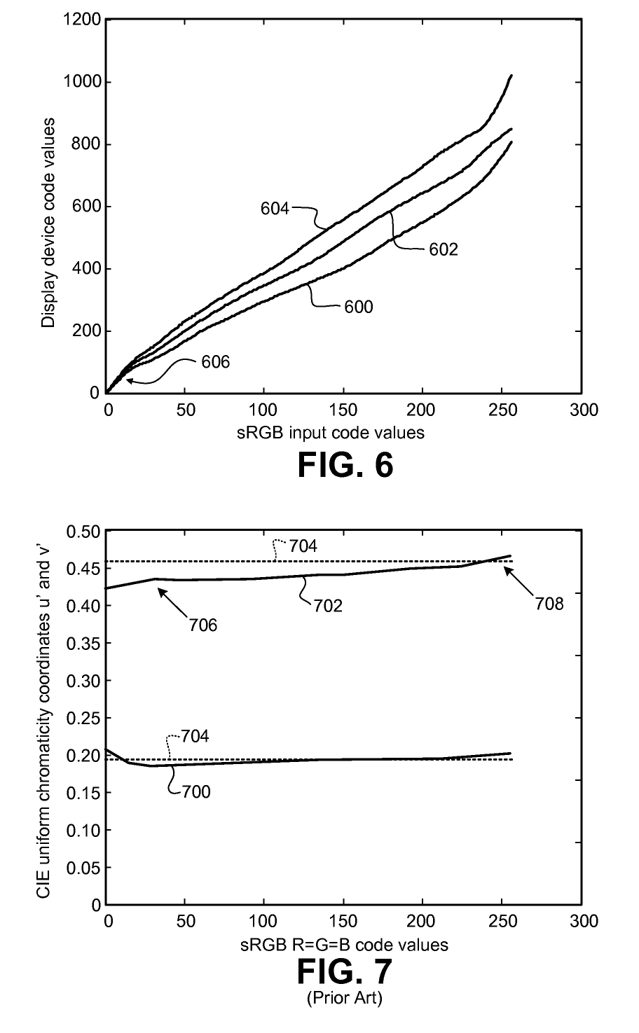

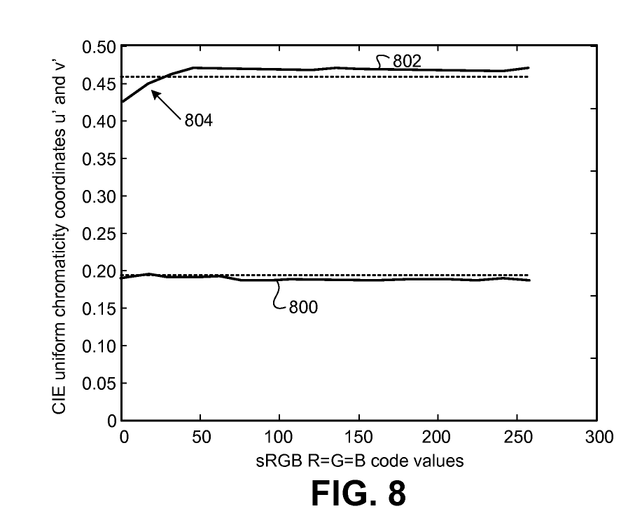

Referring again to FIG. 3, after the original reference grayscale characteristic is created, the original reference grayscale characteristic is modified at block 304 for a specific CIE standard illuminant chromaticity, as will be described in more detail later in conjunction with FIG. 5. Finally, original reference grayscale characteristic is modified at the lower portion of the grayscale characteristic at block 306. The device input values are changed to provide a taper in the lower end of the tables to utilize the panel black point and to improve contrast ratio. This will be described in more detail in conjunction with FIGS. 6 and 8.

In one embodiment in accordance with the invention, the white point and neutral chromaticities (the foregoing assumes the black point tapering improvement is included) are selected from among those chromaticities corresponding to CIE standard daylight illuminants. Under appropriate viewing conditions, these can appear achromatic to an adapted observer, and setting the white point and neutral chromaticities accordingly, through the use of the aforementioned compensation lookup tables, helps greatly with the reproduction of other scene colors. One choice to consider for the reproduced grayscale chromaticity is that of CIE standard illuminant D65. It fits the criteria of being representative of that of a daylight illuminant. It also has formed the basis for the broadcast television encoding system for decades, and also serves as the reference white point chromaticity for the sRGB color space, in which the majority of digital image files that are to be displayed on devices corresponding to one or more embodiments of the invention are encoded. Setting the display device neutral and white point chromaticity to that of D65 produces displayed images that can at times appear warm, or even dingy, depending on the scene content and particular viewing condition. The unique viewing condition of some displays, such as digital picture frames, must be considered and compared to that of the sRGB color space. As was state earlier, it is assumed that there is a fair degree of visual adaptation to the displayed image for the sRGB viewing condition, owing to the viewing angle subtended by an image on a computer display viewed at typical viewing distances. This is typically not the case for smaller display devices, such as digital picture frame displays, which are seen more as objects within a larger viewing environment, the environment itself chiefly controlling the observer's visual adaptation. In these situations, a digital picture frame with a D65 white point and grayscale characteristic are seen as somewhat reddish.

Another white point to consider is that employed on most LCD televisions prevalent in the industry today. The so-called “normal” viewing modes and white points for such displays generally run at correlated color temperatures around 9000K, so the chromaticities of CIE standard illuminant D90 are another consideration for the digital picture frame. Once again, however, a similar situation arises where while the television display appears more or less neutral, this is due to the adaptation to the physically large image, shorter viewing distance, and high luminance, all of which contribute to the observer's visual adaptation, at least to a degree, to the television displayed image. On the other hand, setting the display device neutral and white point chromaticity to that of D90 produces displayed images that often appear cold, depending on the scene content and particular viewing condition.

Therefore, embodiments in accordance with the invention employ an achromatic white point and grayscale chromaticity lying substantially along the continuum on CIE standard daylight illuminant white point chromaticities between D70 and D85, with CIE Standard Illuminant D75 chromaticities being representative.

FIG. 5 depicts grayscale compensation lookup tables for a display device in a first embodiment in accordance with the invention. In the embodiment shown in FIG. 5, the grayscale compensation lookup tables are implemented as one dimensional lookup tables that are computed to produce a grayscale characteristic at a constant chromaticity corresponding to that of CIE standard illuminant D75 throughout the entire characteristic. This is accomplished using known methods for creating grayscale compensation lookup tables.

The horizontal axis represents sRGB input code values and the vertical axis represents display device code values. Plot 500 represents the relationship for red values, plot 502 the relationship for green values, and plot 504 the relationship for blue values. In the embodiment of FIG. 5, the display device code values are 10-bit values. Other embodiments in accordance with the invention can use more or fewer bits than the 10 shown in FIG. 5.

Referring now to FIG. 6, grayscale compensation lookup tables are shown for a display device in a second embodiment in accordance with the invention. Plot 600 represents the relationship for red values, plot 602 the relationship for green values, and plot 604 the relationship for blue values. The grayscale compensation lookup tables in FIG. 6 are computed to produce a grayscale characteristic at a constant chromaticity (CIE standard illuminant D75) and provide a taper in the lower end of the tables (see area 606). The taper in the lower end utilizes the panel black point and improves contrast ratio. The tapering is obtained by manually changing the display device code values at the lower end of the compensation lookup tables to produce the taper in an embodiment in accordance with the invention. In other embodiments in accordance with the invention, the taper can be computed so as to transition from the panel black point chromaticity to the grayscale aim chromaticity according to a linear or nonlinear fashion, and over a lesser or greater code value range.

FIG. 7 depicts a grayscale tracking plot for a liquid crystal display according to the prior art. In FIG. 7, the input sRGB R=G=B code values triads for encoded neutrals are along the horizontal axis, and the CIE uniform chromaticity coordinates u′ and v′ are plotted along the y-axis, the u′ values plotted in plot 700, and the v′ values plotted in plot 702. The dotted lines 704 represent an achromatic reference corresponding to the u′ v′ chromaticity coordinates for CIE standard illuminant D75. Plots 700, 702 depict the u′ v′ chromaticities, respectively, reproduced for that input neutral scale for a particular commercially available LCD display. While the reproduced u′ chromaticities (plot 700) are more or less constant throughout the grayscale, as evidenced by the horizontal nature of plot 700, the reproduced v′ chromaticities (plot 702) are not constant throughout the grayscale, being lower in value at the dark end of the characteristic (area 706) and higher in value at the light end (area 708). The result to the observer is a grayscale characteristic where the highlights may appear somewhat greener than the shadows, or conversely, the shadows may appear somewhat more magenta than the highlights. The above is just one example of how a grayscale characteristic can deviate from a condition of constant chromaticity and resulting visual artifacts.

Referring now to FIG. 8, there is shown a grayscale tracking plot for a liquid crystal display in an embodiment in accordance with the invention. The tracking includes achromatic grayscale tracking throughout the majority of the grayscale, as evidenced by the substantially horizontal plots 800, 802 indicative of constant reproduced u′ and v′ chromaticities, respectively. Plots 800, 802 also include a taper to the chromaticity of the panel black chromaticity at the lowest portion of the grayscale characteristic, as evidenced by the intentional deviation from horizontal in portion 804 of the curve.

Since the chromaticity of the panel black point can vary from display panel to display panel depending on numerous factors including the backlight which may be employed, the specific panel technology, and any light management films and materials that may be incorporated in the display panel, the nature of the final taper will depend on the chromaticity selected for the achromatic neutral and specific panel black point. Thus, other embodiments in accordance with the invention will have different tapers to the chromaticity of the panel black chromaticity at the lowest portion of the grayscale characteristic.

It should be noted that embodiments of the invention may not employ a similar tapering technique at the white end of the curve, tapering the compensation lookup tables to maximum device code values in all three channels. This would seem at first to be desirable in order to maximize panel maximum luminance. However, from the perspective of an observer viewing the display, the compensation table tapering technique, when applied to the white end of the compensation lookup tables, can have an opposite perceived tradeoff as it does when it is applied beneficially at the dark end of the table. The observer will object more to a non achromatic and/or non tracking chromaticity at the white end of the characteristic, and so the reduction in maximum luminance at the white end, necessary to display a white of the selected achromatic chromaticity, is an acceptable tradeoff to maintain achromatic chromaticity tracking at the white end. Doing otherwise has the possibility of displaying white colors and highlights at the panel's native white point chromaticity, and this seldom, if ever, is considered achromatic under typical digital picture frame viewing conditions. Furthermore, employing tapering to panel maximum code value in all three channels can produce inconsistent displayed whites depending on the physical colorimetric characteristics of the particular display panel. In cases where the panel's native white point chromaticity is close to the selected achromatic white point chromaticity, then the reduction in peak white luminance will be reduced and the peak achromatic white will be displayed at a luminance closer to the panel native white point luminance.

Embodiments in accordance with the invention provide an improved grayscale characteristic that allow scene neutrals, captured and encoded according to the sRGB color space, to be reproduced on a display device in a visually preferred manner. The chromaticity coordinates of the reproduced neutrals lie substantially along the continuum of chromaticities corresponding to CIE standard daylight illuminants, and the chromaticities are constant throughout a majority of the display luminance dynamic range. The reproduced neutrals appear achromatic to an observer adapted to the display viewing environment.

Even though specific embodiments of the invention have been described herein, it should be noted that the application is not limited to these embodiments. In particular, any features described with respect to one embodiment may also be used in other embodiments, where compatible. And the features of the different embodiments may be exchanged, where compatible.

### PARTS LIST

100 plot
102 plot
104 area
200 display system
202 image capture device
204 other input device
206 processor
208 memory
210 communications port
212 display
400 original reference grayscale characteristic
402 sRGB reference grayscale characteristic
500 plot for red values
502 plot for green values
504 plot for blue values
600 plot for red values
602 plot for green values
604 plot for blue values
700 plot representing the u′ values
702 plot representing the v′ values
704 dotted lines representing achromatic references
706 area
708 area
800 plot representing the u′ values
802 plot representing the v′ values
804 tapered portion

1. A method for producing an original reference grayscale characteristic for a display panel, the method comprising:
modifying an sRGB reference grayscale characteristic for the display panel to selectively vary a contrast or luminance of certain regions of the sRGB reference grayscale characteristic, wherein the modified sRGB reference grayscale characteristic for the display panel comprises a substantially constant chromaticity corresponding to a particular CIE standard illuminant between D70 and D85; and
tapering a portion of display device code values in the modified sRGB reference grayscale characteristic to a black chromaticity of the display panel at the lower portion of the modified sRGB grayscale characteristic.

2. The method of claim 1, wherein the particular CIE standard illuminant between D70 and D85 comprises CIE standard illuminant D75.
